(19) United States
(12) Patent Application Publication
(10) Pub. No.: US 2025/0191331 A1
(43) Pub. Date: Jun. 12, 2025

(54) MACHINE LEARNING BASED SEAL DETECTION AND AUTHENTICATION

(71) Applicant: SAP SE, Walldorf (DE)

(72) Inventors: Suting Miao, Nanjing (CN); Rongjun Gao, Nanjing (CN); Kefan Zheng, Nanjing (CN)

(21) Appl. No.: 18/536,895

(22) Filed: Dec. 12, 2023

(51) Int. Cl. G06V 10/46; G06V 10/82

(52) U.S. Cl. CPC G06V 10/462; G06V 10/82

(57) ABSTRACT

In some implementations, there is provided seal authentication using machine learning. There may be provided a method including receiving, by a trained machine learning model, a document to be authenticated; detecting, by the trained machine learning model, whether the document contains a seal; in response to detecting the seal, providing the seal extracted by the trained machine learning model for authentication; authenticating the extracted seal in a scale invariant domain by at least using a comparison of the extracted seal and a model seal to determine a similarity score; and providing the similarity score as an indication of whether the extracted seal is authentic. Related systems, methods, and articles of manufacture are also disclosed.

### TECHNICAL FIELD

The subject matter disclosed herein relates to automated authentication and detection of seals.

### BACKGROUND

A seal refers to an image, such as a stamp or a mark, used to authenticate a document, such as an electronic document. For example, a seal may be used in part to identify an entity, such as a person, company, and/or other entity. Alternatively, or additionally, a seal may be used to authenticate (e.g., validate) the entity. In some countries for example, the seal on a document represents that the entity associated with the seal is bound to the terms of the document. To illustrate further, when company X places its seal on a document, the seal on the document represents a binding obligation, akin to a signature or e-signature placed on a document, for example.

### SUMMARY

In some implementations, there is provided authentication of seals. In some embodiments, there may be provide a method that includes receiving, by a machine learning model, one or more training documents and one or more labels indicating whether the one or more training documents include a seal; training, using the one or more training documents and the one or more labels, the machine learning model to perform a task of detecting seals in one or more documents; receiving, by the trained machine learning model, a document to be authenticated; detecting, by the trained machine learning model, whether the document contains a seal; in response to detecting the seal, providing the seal extracted by the trained machine learning model for authentication; authenticating the extracted seal in a scale invariant domain by at least using a comparison of the extracted seal and a model seal to determine a similarity score; and providing the similarity score as an indication of whether the extracted seal is authentic.

In some variations, one or more of the features disclosed herein including the following features can optionally be included in any feasible combination. The machine learning model may include a convolutional neural network. The machine learning model may include a faster regional proposal network. The authenticating may include preprocessing the extracted seal to remove background noise from the extracted seal. The background noise may be removed using a first filtering algorithm if the extracted seal is in color. The background noise may be removed using a second filtering algorithm if the extracted seal is in gray scale. The extracted seal and the model seal may be transformed into the scale invariant domain using one or more scale invariant feature transform (SIFT) features of the extracted seal and the model seal and in response transforming, registering, using the one or more scale invariant feature transform (SIFT) features, the transformed, extracted seal and the transformed model seal to form a residual image. The similarity score may be determined based on the residual image.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for seal detection, in accordance with some embodiments;

FIG. 2 depicts an example of the ML model inference phase, in accordance with some embodiments;

FIG. 3 depicts an example of a process used by a seal authenticator, in accordance with some embodiments;

FIG. 4 depicts an example of a seal authentication process, in accordance with some embodiments; and

FIG. 5 depicts another example of a system, in accordance with some embodiments.

### DETAILED DESCRIPTION

Although seals can be used on documents, there may be one or more challenges with respect to the validation of a seal to confirm a seal's authenticity. Indeed, it can be difficult to identify whether a seal is authentic, and these challenges can lead to, or be associated with, issues, such as invalid agreements, fraud, wasted resources (e.g., in terms of compute, memory, and network resources), and/or the like. To authenticate a seal on an electronic document for example, an entity may use one or more manual checks to confirm the authenticity of a seal.

In some embodiments, there is provided an automatic process to detect a seal on an electronic document and verify the authenticity of a seal on, or associated with, the electronic document, such as a contract or any other type of document. This automatic process may, in some implementations, reduce some, if not all, of the noted issues with manual seal authentication.

In some embodiments, there may be provided an image denoising process to denoise the image containing a seal (“seal image”). The seal image denoising may be performed as a preprocessing step before additional processing, such as the additional processing associated with authentication of the seal. The use of image denoising preprocessing may improve the reliability of the authentication of a seal and lead to improved indications (e.g., score, likelihood, and/or the like) of whether a seal is authentic. Moreover, the use of denoising may reduce processing time as repeated authentication runs to authenticate a seal can be reduced or eliminated.

In some embodiments, the type of denoising used to denoise a seal image may be selected based on the kind of seal image being used as the seal. The use of different types of denoising processes may also reduce processing time caused by repeated authentication runs to authenticate a seal.

In some embodiments, the preprocessing of a seal image may include removal of “scattered” white pixels from a seal image. This removal may enhance the differences between two seal images being compared during seal authentication (e.g., the image being authenticated and a reference, or model, seal being used for a comparison during the authentication).

Despite the fact that registration is used to compare a seal image being authenticated with a reference seal as part of seal image authentication, it may be difficult to align two seal images during the comparison. This difficulty with the alignment may be due in part to the original properties of the two seal images (e.g., properties such as clarity of the seal image, angle or perspective of the camera imaging the seal, and/or the like). For example, these slight differences may appear as “scattered” white pixels on a residual image, which may also cause inaccurate similarity scores. As noted, the scattered white pixels are removed (e.g., filtered) from the residual image. The scattered white pixels may be removed to magnify the obvious differences between the two images and eliminates slight errors. This operation further improves the accuracy and confidence of the similarity score. The residual image refers to an image that results from registration of the two seal images (e.g., an image resulting from the difference between the two seal images). For example, the white pixels may comprise any remaining pixels (e.g., white pixels) that indicate a difference between a reference seal and a seal being authenticated. If the pixels of the two seal images overlap (e.g., in the same positions), the corresponding overlapping pixels are removed with the XOR operator, so then the residual image only includes or indicates the difference.

In some embodiments, an automatic seal detection process may be used. For example, one or more documents (e.g., contracts or other types of documents) with seals may be obtained from, for example, a database, a public dataset, or other source of electronic documents having seals. The documents may undergo image preprocessing to provide some initial cleanup of the documents, such as denoising and/or other types of preprocessing. These preprocessed documents may be placed into a dataset of documents. In this dataset, the seal of each document is labeled (e.g., with a reference label identifying the seal), so that the dataset and labels can be used to train a machine learning (ML) model. For example, document images may be processed and a bounding box may be placed around a seal image of a document to indicate the presence of a seal in the document, and a file may contain a label for each document image containing the seal.

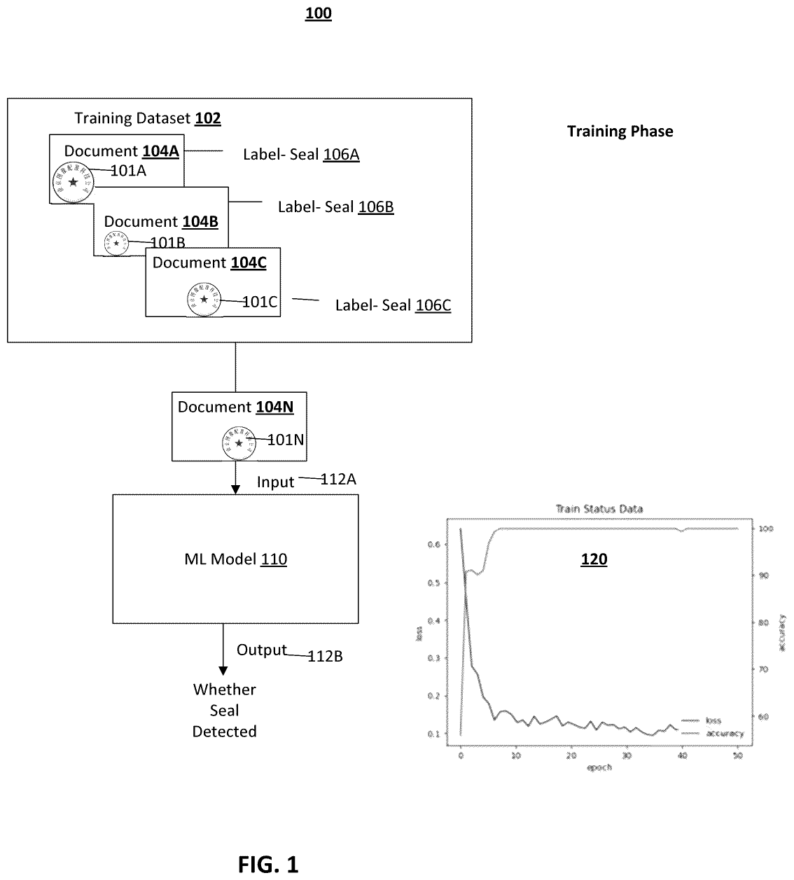

FIG. 1 depicts an example of a system 100 for seal detection, in accordance with some embodiments. The system also includes a machine learning (ML) model 110. The ML model may be trained (as part of a training phase) to learn how to detect seals in electronic documents.

The system 100 may include a training dataset 102 of documents 104A-C that have been labeled 106A-C to indicate whether a document contains a seal. In the example of FIG. 1, the seals 101A-N correspond to a circle with a star inside the circle but the seals 101A-N may take other shapes or designs as well. Alternatively, or additionally, one or more of the seals 101A-N may be in color (e.g., a red seal, a blue seal, a yellow seal, or other color), although one or more of the seals may not be in color (e.g., a black and white, such as a gray scale seal). Although the example of FIG. 1 shows a training set where all of the documents include seals, the training set may include documents without seals as well (in which case, the labels may indicate no seal is present).

With the labeled dataset, the ML model 110 may be trained. For example, one or more of the documents 104A-C may be provided as an input to the ML model 110. In the example of FIG. 1, a document, such as document 104N as well as other documents 104A-C and the like, is provided as at an input 112A to the ML model 110, such that the weights of the ML model are adjusted until the output 112B of the ML model correctly identifies whether the corresponding input document includes a seal (e.g., adjusting the weights to minimize an error or maximize an accuracy). As the documents includes labels, whether the output 112B correctly identifies a seal in the document can be determined based on a check of the label (e.g., checking whether a seal is present or not, and if present, it will show the bounding box of the seal, so that we can extract the seal out). Specifically, this training teaches the ML model (in a training phase) to perform the task of seal detection in a document.

Although the example of FIG. 1 depicts only 4 training documents, other quantities of training documents may be used as well. Moreover, the documents mention herein are scanned or electronic documents, unless expressly described otherwise.

FIG. 1 also depicts a graph 120. The graph shows that during training of the ML model 110, the training repeats until the accuracy of the seal detection reaches a threshold amount. For example, the training documents 104A-N are provided and the ML model's weights are adjusted for each epoch (e.g., passing of a dataset of training documents 104A-N) until the accuracy reaches a threshold amount (e.g., 99%, 100%, and/or other threshold amount of accuracy).

To illustrate further, the ML model 110 may comprise a Faster RCNN model. Given a document image and a corresponding label for the document (e.g., a label comprising a file indicating whether the document image contains a seal), the ML model is trained and after 20 epochs for example, the ML model may pause training to determine (and/or record) performance, such as accuracy and loss as shown at the graph 120. The training loss refers to the average loss calculated over all training examples in a single iteration or epoch during the training of a machine learning model. The loss is a measure of the difference between the predicted values and the actual target values for the training examples. And in this example, since the accuracy is below a threshold amount of accuracy of for example system 100, the training of the ML model is resumed until the accuracy is determined to have reached the threshold amount of accuracy.

In some embodiments, the ML model 110 may comprise at least one convolutional neural network (CNN), although other types of ML models may be used to perform the task of detecting seals in the documents. Alternatively, or additionally, the ML model may comprise a Faster Regional Proposal Network CNN (or Faster RCNN, for short).

After the ML model 110 is trained, the ML model 110 may be used in an inference phase to perform a task of automatically detecting seals in documents, such as other documents that are outside the noted training dataset above.

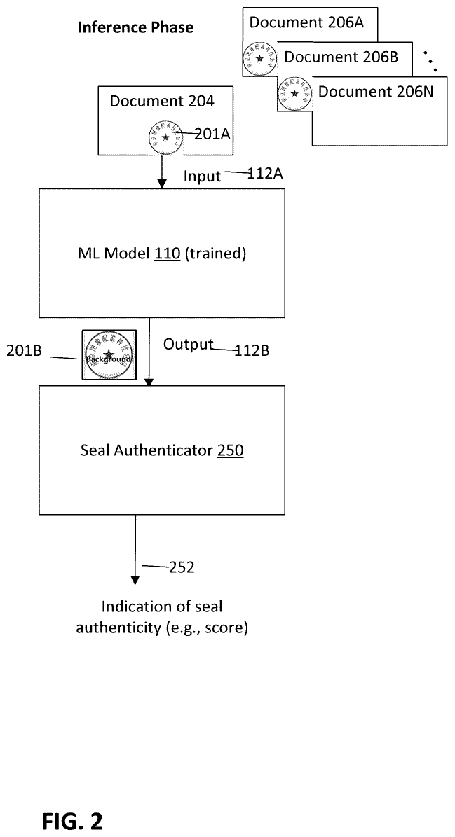

FIG. 2 depicts an example of the ML model 110 inference phase, in accordance with some embodiments. The trained ML model 110 may receive a document 204, which in this example is a document being authenticated. The trained ML model may be trained to detect the seal 201A. For example, the trained ML model may receive as the input 112A the document 204 and output 112B an indication that the seal 201A is present in the document 204. Unlike the training phase, the document 204 is not a training document so there is no label to indicate whether a seal is present in the document as the task of determining whether the seal is present is the task of the ML model 110. Alternatively, or additionally, the ML model 110 may be trained to identify the location of the seal in the document (e.g., with the placement of a bounding box) and/or segment (e.g., extract into a separate image) the seal 201A from the document 204. Alternatively, or additionally, the seal 201A may be segmented from the document 204 using an image segmenter that extracts the seal image from the document (e.g., identifying the bounding box and extracting the seal image from the document).

The seal authenticator 250 receives (as an input) a seal image being authenticated. For example, the output 112B of the trained ML model 110 may be a seal 201B detected and/or extracted from document 204. The seal authenticator may preprocess the detected seal 201B to remove noise, such as background and/or other types of noise, and provides at output 252 an indication, such as a similarity score, regarding the authenticity of the seal. In some embodiments, a ML model may be used to segment to seal, and the ML model may be the same ML model 110 or another ML model. Alternatively, or additionally, other types image segmentation may be used, such as clustering, binarization, and/or the like to segment the seal from the surrounding document.

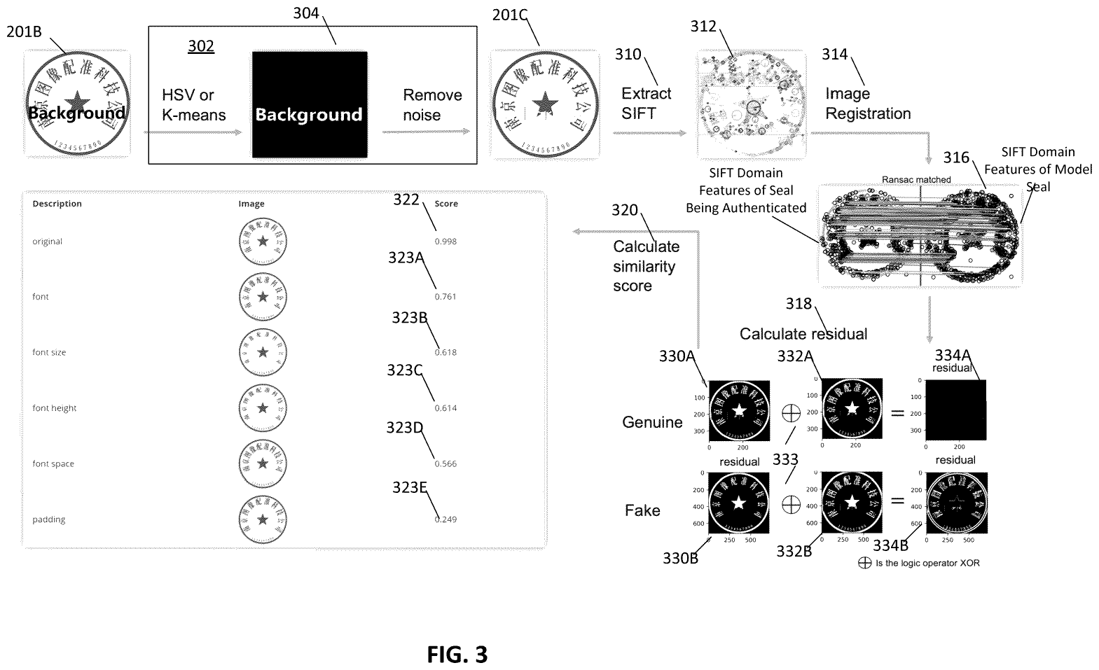

FIG. 3 depicts an example of some of the processes of the seal authenticator 250. For example, the seal authenticator may receive (as an input) the seal 201B, which has been detected and/or extracted by the ML model 110.

The seal 201B may be preprocessed at 302 to remove noise, such as background image noise, to yield a preprocessed seal image 201C (e.g., denoised). In some embodiments, the seal 201B may be preprocessed at 302 based on whether or not the seal 201B is a color seal or a gray seal. For example, the seal 201B may categorized as either a “color” category seal if the seal 201B is in color or a “gray” category seal if the seal 201B is in black and white or gray scale. In some embodiments, the seal authenticator detects (e.g., using the values of the pixels) whether the seal is color or black and white (also referred to as gray scale).

If the seal 201B is a color category seal, the seal 201B may be converted at 302 into another form, such as a HSV (hue, saturation, value) image, RGB (red, green, blue) image, and/or the like, to enable extracting a given color. From the converted HSV image for example, a first component (e.g., the red component) of the image may be extracted as in this example the seal 201B is a red seal (where red has a hue value between 0 and 60 degrees) while the other color components of the converted image are filtered out (e.g., removed) to remove noise, such as background image noise. If however the seal is blue, the first component (e.g., blue) may be extracted (e.g., where the blue hue value is between 241 and 300 degrees), while the other color components are filtered out to remove noise, such as background image noise 304.

If the seal 201B is a gray category seal for example, the denoising process at 302 for the seal 201B may include the following. First, a k-means algorithm (which is also referred to as k-means clustering) is applied to image of the seal 201B. The k-means clustering may perform a ternary (e.g., three-part) clustering on the gray scale values of the of the seal 201B, such that the gray scale values of the middle class (e.g., between 100-200) are kept (as they capture the seal itself), while gray scale values close to 255 (e.g., between 201-255) may be removed (or filtered out) as they are considered part of the image's white background and gray scale value close to 0 (e.g., within 0-99) may be removed (or filtered out) as these values may be considered black interference.

After one or more seals have been denoised (at 302 as noted above), the preprocessed seal image 201C may be used in a seal registration process to align the preprocessed seal image 201C to one or more other seals (e.g., reference or model seals considered authentic) that are used during a comparison to assess the authenticity of preprocessed seal image 201C. The seal registration may be performed using a seal's scale invariant feature transform (SIFT) features. In essence, the seal registration using SIFT aligns and overlaps two images but in a scale invariant feature domain. The SIFT (or scale invariant) domain removes (or reduces) any affects caused by different sized seal images. When the two images are aligned (in the scale invariant domain) as part of seal registration, the aligned images may be compared to determine a similarity between two image seals (e.g., a test seal being evaluated for authenticity versus a reference or model seal).

In the example of FIG. 3, the preprocessed seal image 201C (which is being authenticated) and at least one genuine seal image (e.g., a model or reference seal considered authentic) are processed based on the SIFT algorithm. The SIFT algorithm as noted provides scale invariance as well as some rotation translation invariance. In the case of SIFT, key points are extracted to compare the preprocessed seal image 201C and at least one genuine seal image (e.g., a reference or model seal image considered authentic). For example, key points in the images are detected using for example filtering, such as a Gaussian filters at different scales, to form a Difference of Gaussian and key points are obtained over the different scales of the images. Next, a unique descriptor for each key point is assigned and matching pairs of key points between images are determined. If there are any mismatched key point pairs, the mismatched key points may be removed using an algorithm, such as the Random Sample Consensus (RANSAC) algorithm. Next, the two images are projected using a transformation matrix, such that the transformed pixels of the preprocessed seal image 201C and the transformed pixels of the at least one genuine (or reference/model) seal image are then aligned to form a residual image, such as the residual images at 334A and 334B. The registration (which compares the two seal images) is thus done in a size invariant domain.

Referring to FIG. 3, the SIFT algorithm is applied, at 310, to the preprocessed seal image 201C to extract the features (e.g., SIFT features) and to the at least one genuine seal image to extract the features (e.g., SIFT features). At 312, the preprocessed seal image 201C transformed using the SIFT algorithm into the SIFT domain is depicted. At 314, image registration is performed in the SIFT domain and the comparison of key points is depicted at 316 (the key points of the SIFT domain image of preprocessed seal image 201C and the key points of the SIFT domain image of the at least one genuine seal image).

At 316, the features of the two images are extracted in the SIFT domain. In other words as the preprocessed seal image 201C and the genuine or model seals being used for the comparison can have different sizes, angles, etc., the registration may determine features in the SIFT domain (“SIFT features) of each image and extracted as shown at 316, and then matching these features of the two seals, so key point in each seal are registered to the same size and position (at 316, the lines link the key points (or features) in the seals that are the same, such as same pixel value and position). In some implementations, the seal authenticator 250 includes or is coupled to a database of model seals which have been authenticated and may be considered genuine.

After the two seal images are registered (e.g., aligned), a residual image may be determined at 318. For example, each pixel of the two seal images may be processed using an XOR operation 333. If the pixel value at the same position in the two images is the same, the pixel at the same position in the residual image is set to 0 (which appears to be black in a residual image); otherwise, the pixel value is set to be a value of 255 which corresponds to a white pixel. Therefore, the black portion in the residual image indicates pixels (and their positions) in the two images that are the same, which means this part of the two seals can overlap, and the white part indicates the pixels at a position in the two images that are different and do not overlap. As such, the more white pixels in the residual image indicates that there are more pixels that do not overlap between the genuine (e.g., reference or model) seal and the seal being authenticated, and, as such, there is a higher possibility the seal being authenticated is a fake (i.e., not authentic). By contrast, a residual image that is all (or almost all black) is due to more pixels that overlap (same pixels in same positions of the genuine seal and the seal being authenticated), so an all (or mostly black) residual image may indicate the seal being authenticated is likely authentic. Referring to FIG. 3, the seal being authenticated 330A (in the SIFT domain) and a genuine seal 332A (in the SIFT domain) undergo an XOR operation 333 to yield residual image 334A, which is all black so the residual image indicates that the seal being authenticated 330A is likely authentic and thus not fake. On the other hand, the seal being authenticated 330B (in the SIFT domain) and a genuine seal 332B (in the SIFT domain) undergo an XOR operation 333 to yield residual image 334B, which includes “white” pixels, so the residual image 334B indicates that the seal being authenticated 330B is likely to be a fake. In this example, the quantity of white (e.g., to pixels in the registration that do not overlap with respect to value and position) can be used as a metric, such as a score to indicate a similarity between the seal being authenticated and the reference/model seal.

At 320, a similarity score may be determined by for example calculating a residual matrix of the two images and use this residual matrix as the basis for distinguishing the authenticity of the seal. For example, despite the residual image being indicative of the similarity of the two seals, a similarity score may be calculated to indicate the authenticity of a given seal, such as seal 201B. To determine a similarity score, the similarity score is determined by for example dividing the quantity of white pixels of the residual image by the quantity of pixels in residual image (e.g., the union of two images, such as the union of the seal being authenticated 330B and a genuine seal 332B). Alternatively, or additionally, the ratio of black to white pixels in the residual image may be used as a similarity score.

At 322, a similarity score is calculated for two seal images which are both the same authentic image. In the example of the two seal images being the same, the similarity score may be about 1 (e.g., close to 1 at 0.998). But if two seal images are slightly different in some way, such as font 323A, font size 323B, or font height 323C, font spacing 323D, or padding 323E, as would be the case if a seal is doctored or a fake, the similarity score is lower than a threshold amount (e.g., 0.8), so the calculation of the similarity score can be used to effectively indicate that fake seals (as indicated by the scores 323A-E being less than the threshold amount) are indeed fake (i.e., not an authentic seal), while any similarity score at or above the threshold amount would indicate the seal as likely being authentic.

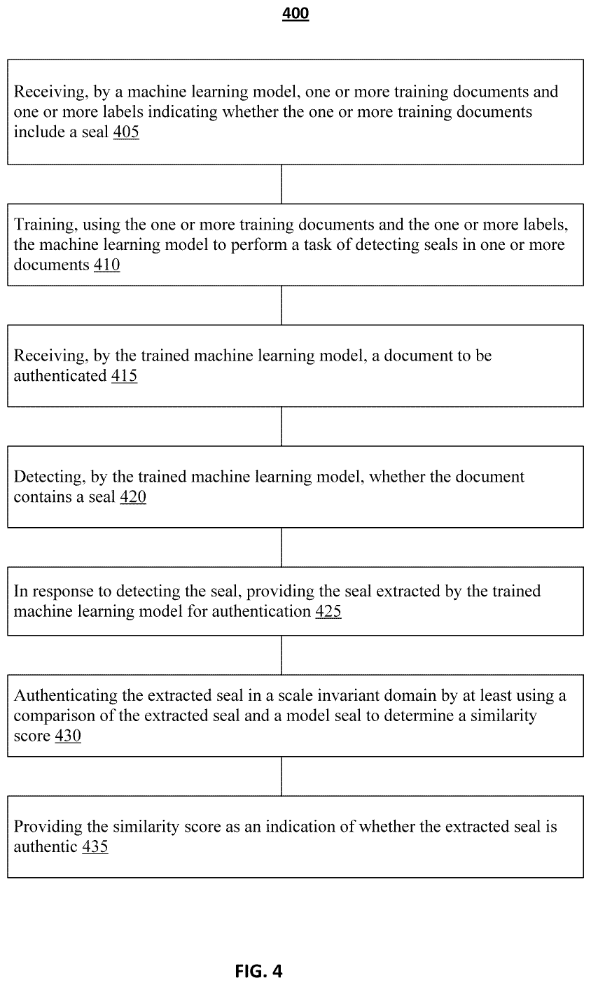

FIG. 4 depicts an example of a seal authentication process, in accordance with some embodiments.

At 405, a machine learning model may receive one or more training documents and one or more labels indicating whether the one or more training documents include a seal, in accordance with some embodiments. For example, the ML model 110 may receive one or more documents 104A-N from a training dataset 102, which further includes labels 106A-C for the documents. The labels may indicate whether a label is present in a corresponding document.

At 410, the machine learning model may be trained using the one or more training documents and the one or more labels, the training enables the machine learning model to perform a task of detecting seals in one or more documents, in accordance with some embodiments. For example, the weight in at least one layer of the ML model 110 may be adjusted until the ML models can detect that a seal is present in the training documents 104A-N. As the training documents are labeled, the ML model can adjust the weights until the ML model accurate detects the seals in the documents of the training set.

At 415, the trained machine learning model 110 may receive a document to be authenticated, in accordance with some embodiments. When the ML model 110 is trained, it can be used in an inference phase to detect whether documents, such as document 204, includes a seal. In the example of FIG. 2, the document 204 is being authenticated. As noted, the document 204 (as well as other documents 206A-N) may be authenticated.

At 420, the trained machine learning model 110 may detect whether the document contains a seal, in accordance with some embodiments. For example, the ML model 110 at FIG. 3 may detect the presence of seal 201B in the document 204.

In response to detecting the seal, the seal (which is detected and extracted by the trained machine learning model 110) may be provided at 425, in accordance with some embodiments. For example, the seal 201B detected by the ML model 110 may be extracted from the document 204 provided to the seal authenticator 250 for authentication.

At 430, the extracted seal may be authenticated. For example, the extracted seal may be authenticated in a size (e.g., scale) invariant domain, such as the SIFT domain or other domain (e.g., Fourier Domain, Fast Fourier Transform Domain, and/or other size invariant domains) using a comparison of the extracted seal and a model seal to determine a similarity score. For example, the authenticating may include at least preprocessing the extracted seal to remove background noise from the extracted seal, wherein the background noise is removed using a first filtering algorithm if the extracted seal is in color or using a second filtering algorithm if the extracted seal is in gray scale, transforming the extracted seal and a model seal into a scale invariant domain, in response transforming, registering the transformed, extracted seal and the transformed model seal to form a residual image, determining a similarity score based on the residual image. Referring to FIG. 3, the extracted seal 201B may be authenticated by preprocessing the extracted seal to remove background noise at 302. The background noise may be removed using a first filtering algorithm if the extracted seal is in color. For example, if the seal 201B is a color category seal, the seal may be converted into another form to enable extraction of a given color. The second filtering algorithm may be used to for a gray scale seal. For example, if the seal 201B is a gray scale seal a k-means algorithm approach as noted above may be used keep the seal image while removing background and other noise. As noted, the extracted seal and a model seal may transformed into a scale invariant domain, such as the SIFT noted at 314 above where registration can take place in a scale invariant manner. When the seals are transformed into the SIFT domain for example, the transformed, extracted seal and the transformed model seal may be registered (see, e.g., 314 above) to form a residual image, such as residual image 334A or 334B. The residual image may be used to determine a similarity score based on the residual image, such as the quantity of white pixels in the residual image.

At 435, the similarity score may be provided as an indication of whether the extracted seal is authentic. For example, a similarity score greater than a threshold value such as 90% may indicate that the seal 201B is authentic, while a similarity score below 90% may indicate a fake image, although other threshold values may be used as well.

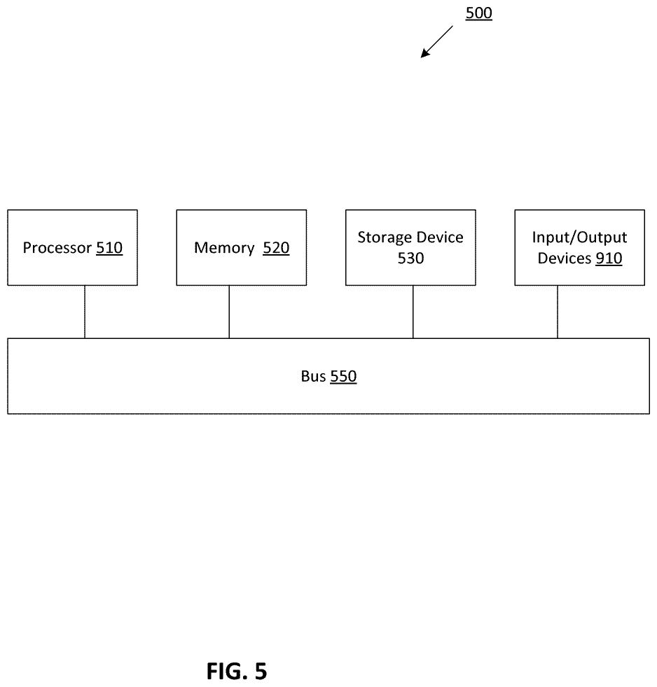

In some implementations, the current subject matter may be configured to be implemented in a system 500, as shown in FIG. 5. For example, aspects disclosed herein may be at least in part physically comprised on system 500. To illustrate further system 500 may further include an operating system, a hypervisor, and/or other resources, to provide virtualize physical resources (e.g., via virtual machines). The system 500 may include a processor 510, a memory 520, a storage device 530, and an input/output device 540. Each of the components (e.g., 510, 520, 530 and 540) may be interconnected using a system bus 550. The processor 510 may be configured to process instructions for execution within the system 500. In some implementations, the processor 510 may be a single-threaded processor. In alternate implementations, the processor 510 may be a multi-threaded processor.

The processor 510 may be further configured to process instructions stored in the memory 520 or on the storage device 530, including receiving or sending information through the input/output device 540. The memory 520 may store information within the system 500. In some implementations, the memory 520 may be a computer-readable medium. In alternate implementations, the memory 520 may be a volatile memory unit. In yet some implementations, the memory 520 may be a non-volatile memory unit. The storage device 530 may be capable of providing mass storage for the system 500. In some implementations, the storage device 530 may be a computer-readable medium. In alternate implementations, the storage device 530 may be a floppy disk device, a hard disk device, an optical disk device, a tape device, non-volatile solid state memory, or any other type of storage device. The input/output device 540 may be configured to provide input/output operations for the system 500. In some implementations, the input/output device 540 may include a keyboard and/or pointing device. In alternate implementations, the input/output device 540 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A computer-implemented method, comprising: receiving, by a machine learning model, one or more training documents and one or more labels indicating whether the one or more training documents include a seal; training, using the one or more training documents and the one or more labels, the machine learning model to perform a task of detecting seals in one or more documents; receiving, by the trained machine learning model, a document to be authenticated; detecting, by the trained machine learning model, whether the document contains a seal; in response to detecting the seal, providing the seal extracted by the trained machine learning model for authentication; authenticating the extracted seal in a scale invariant domain by at least using a comparison of the extracted seal and a model seal to determine a similarity score; and providing the similarity score as an indication of whether the extracted seal is authentic.
Example 2: The computer-implemented method of Example 1, wherein the machine learning model comprises a convolutional neural network.
Example 3: The computer-implemented method of any of Examples 1-2, wherein the machine learning model comprises a faster regional proposal network.
Example 4: The computer-implemented method of any of Examples 1-3, wherein the authenticating further comprises: preprocessing the extracted seal to remove background noise from the extracted seal.
Example 5: The computer-implemented method of any of Examples 1-4, wherein the background noise is removed using a first filtering algorithm if the extracted seal is in color.
Example 6: The computer-implemented method of any of Examples 1-5, wherein the background noise is using a second filtering algorithm if the extracted seal is in gray scale.
Example 7: The computer-implemented method of any of Examples 1-6 further comprising: transforming the extracted seal and the model seal into the scale invariant domain using one or more scale invariant feature transform (SIFT) features of the extracted seal and the model seal; and in response transforming, registering, using the one or more scale invariant feature transform (SIFT) features, the transformed, extracted seal and the transformed model seal to form a residual image.
Example 8: The computer-implemented method of any of Examples 1-7 further comprising: determining the similarity score based on the residual image.
Example 9: A system comprising at least one processor and at least one memory including instructions, which when executed causes operations comprising: receiving, by a machine learning model, one or more training documents and one or more labels indicating whether the one or more training documents include a seal; training, using the one or more training documents and the one or more labels, the machine learning model to perform a task of detecting seals in one or more documents; receiving, by the trained machine learning model, a document to be authenticated; detecting, by the trained machine learning model, whether the document contains a seal; in response to detecting the seal, providing the seal extracted by the trained machine learning model for authentication; authenticating the extracted seal in a scale invariant domain by at least using a comparison of the extracted seal and a model seal to determine a similarity score; providing the similarity score as an indication of whether the extracted seal is authentic.
Example 10: The system of Example 9, wherein the machine learning model comprises a convolutional neural network.
Example 11: The system of any of Examples 9-10, wherein the machine learning model comprises a faster regional proposal network.
Example 12: The system of any of Examples 9-11, wherein the authenticating further comprises: preprocessing the extracted seal to remove background noise from the extracted seal.
Example 13: The system of any of Examples 9-12, wherein the background noise is removed using a first filtering algorithm if the extracted seal is in color.
Example 14: The system of any of Examples 9-13, wherein the background noise is using a second filtering algorithm if the extracted seal is in gray scale.
Example 15: The system of any of Examples 9-14 further comprising: transforming the extracted seal and the model seal into the scale invariant domain using one or more scale invariant feature transform (SIFT) features of the extracted seal and the model seal; and in response transforming, registering, using the one or more scale invariant feature transform (SIFT) features, the transformed, extracted seal and the transformed model seal to form a residual image.
Example 16: The system of any of Examples 9-115 further comprising: determining the similarity score based on the residual image.
Example 17: A non-transitory computer-storage medium including instructions, which when executed by at least one processor, causes operations comprising: receiving, by a machine learning model, one or more training documents and one or more labels indicating whether the one or more training documents include a seal; training, using the one or more training documents and the one or more labels, the machine learning model to perform a task of detecting seals in one or more documents; receiving, by the trained machine learning model, a document to be authenticated; detecting, by the trained machine learning model, whether the document contains a seal; in response to detecting the seal, providing the seal extracted by the trained machine learning model for authentication; authenticating the extracted seal in a scale invariant domain by at least using a comparison of the extracted seal and a model seal to determine a similarity score; and providing the similarity score as an indication of whether the extracted seal is authentic.
Example 18: The non-transitory computer-storage medium of Example 17, wherein the machine learning model comprises a convolutional neural network.
Example 19: The non-transitory computer-storage medium of any of Examples 17-18, wherein the machine learning model comprises a faster regional proposal network.
Example 20: The non-transitory computer-storage medium of any of Examples 17-19, wherein the authenticating further comprises: preprocessing the extracted seal to remove background noise from the extracted seal.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving, by a machine learning model, one or more training documents and one or more labels indicating whether the one or more training documents include a seal;
training, using the one or more training documents and the one or more labels, the machine learning model to perform a task of detecting seals in one or more documents;
receiving, by the trained machine learning model, a document to be authenticated;
detecting, by the trained machine learning model, whether the document contains a seal;
in response to detecting the seal, providing the seal extracted by the trained machine learning model for authentication;
authenticating the extracted seal in a scale invariant domain by at least using a comparison of the extracted seal and a model seal to determine a similarity score; and
providing the similarity score as an indication of whether the extracted seal is authentic.

2. The computer-implemented method of claim 1, wherein the machine learning model comprises a convolutional neural network.

3. The computer-implemented method of claim 1, wherein the machine learning model comprises a faster regional proposal network.

4. The computer-implemented method of claim 1, wherein the authenticating further comprises:
preprocessing the extracted seal to remove background noise from the extracted seal.

5. The computer-implemented method of claim 4, wherein the background noise is removed using a first filtering algorithm if the extracted seal is in color.

6. The computer-implemented method of claim 4, wherein the background noise is using a second filtering algorithm if the extracted seal is in gray scale.

7. The computer-implemented method of claim 4 further comprising:
transforming the extracted seal and the model seal into the scale invariant domain using one or more scale invariant feature transform (SIFT) features of the extracted seal and the model seal; and
in response transforming, registering, using the one or more scale invariant feature transform (SIFT) features, the transformed, extracted seal and the transformed model seal to form a residual image.

8. The computer-implemented method of claim 7 further comprising:
determining the similarity score based on the residual image.

9. A system comprising at least one processor and at least one memory including instructions, which when executed causes operations comprising:
receiving, by a machine learning model, one or more training documents and one or more labels indicating whether the one or more training documents include a seal;
training, using the one or more training documents and the one or more labels, the machine learning model to perform a task of detecting seals in one or more documents;
receiving, by the trained machine learning model, a document to be authenticated;
detecting, by the trained machine learning model, whether the document contains a seal;
in response to detecting the seal, providing the seal extracted by the trained machine learning model for authentication;
authenticating the extracted seal in a scale invariant domain by at least using a comparison of the extracted seal and a model seal to determine a similarity score; and
providing the similarity score as an indication of whether the extracted seal is authentic.

10. The system of claim 9, wherein the machine learning model comprises a convolutional neural network.

11. The system of claim 9, wherein the machine learning model comprises a faster regional proposal network.

12. The system of claim 9, wherein the authenticating further comprises:
preprocessing the extracted seal to remove background noise from the extracted seal.

13. The system of claim 12, wherein the background noise is removed using a first filtering algorithm if the extracted seal is in color.

14. The system of claim 12, wherein the background noise is using a second filtering algorithm if the extracted seal is in gray scale.

15. The system of claim 9 further comprising:
transforming the extracted seal and the model seal into the scale invariant domain using one or more scale invariant feature transform (SIFT) features of the extracted seal and the model seal; and
in response transforming, registering, using the one or more scale invariant feature transform (SIFT) features, the transformed, extracted seal and the transformed model seal to form a residual image.

16. The system of claim 9 further comprising:
determining the similarity score based on the residual image.

17. A non-transitory computer-storage medium including instructions, which when executed by at least one processor, causes operations comprising:
receiving, by a machine learning model, one or more training documents and one or more labels indicating whether the one or more training documents include a seal;
training, using the one or more training documents and the one or more labels, the machine learning model to perform a task of detecting seals in one or more documents;
receiving, by the trained machine learning model, a document to be authenticated;
detecting, by the trained machine learning model, whether the document contains a seal;
in response to detecting the seal, providing the seal extracted by the trained machine learning model for authentication;
authenticating the extracted seal in a scale invariant domain by at least using a comparison of the extracted seal and a model seal to determine a similarity score; and
providing the similarity score as an indication of whether the extracted seal is authentic.

18. The non-transitory computer-storage medium of claim 17, wherein the machine learning model comprises a convolutional neural network.

19. The non-transitory computer-storage medium of claim 17, wherein the machine learning model comprises a faster regional proposal network.

20. The non-transitory computer-storage medium of claim 17, wherein the authenticating further comprises:
preprocessing the extracted seal to remove background noise from the extracted seal.
